(19) United States
(12) Patent Application Publication
(10) Pub. No.: US 2026/0332776 A1
(43) Pub. Date: Oct. 22, 2026

(54) SYSTEMS AND METHODS FOR BLEND MODE CODING

(71) Applicant: Tencent America LLC, Palo Alto, CA (US)

(72) Inventors: Qingyang ZHOU, Palo Alto, CA (US); Liang Zhao, Palo Alto, CA (US); Madhu Peringassery Krishnan, Palo Alto, CA (US); Tianqi Liu, Palo Alto, CA (US); Shan Liu, Palo Alto, CA (US)

(21) Appl. No.: 19/321,140

(22) Filed: Sep. 5, 2025

Related U.S. Application Data
(60) Provisional application No. 63/790,587, filed on Apr. 17, 2025.

(51) Int. Cl. H04N 19/14; H04N 19/105; H04N 19/176; H04N 19/70

(52) U.S. Cl. CPC H04N 19/14; H04N 19/105; H04N 19/176; H04N 19/70

(57) ABSTRACT

An example method of video decoding includes receiving video data comprising a plurality of blocks, including a current block. The method also includes, when the current block is to encoded in a blend mode, identifying a set of reference samples for the current block and deriving an angular prediction value for the current block based on a first reference sample from the set of reference samples, a second reference sample from the set of reference samples, a coordinate of a current sample of the current block, a length of the current block, and a rounding offset, and deriving a refined prediction value for the current block using a weighted sum of the second reference sample and the angular prediction value. The method further includes decoding the current block based on the refined prediction value.

### RELATED APPLICATIONS

This application claims priority U.S. Provisional Patent Application No. 63/790,587, entitled “For Blend Mode” filed Apr. 17, 2025, which is hereby incorporated by reference in its entirety.

### TECHNICAL FIELD

The disclosed embodiments relate generally to video coding, including but not limited to systems and methods for blend mode predictions in video encoding and decoding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored.

Multiple video codec standards have been developed. For example, video coding standards include AOMedia Video 1 (AV1), Versatile Video Coding (VVC), Joint Exploration test Model (JEM), High-Efficiency Video Coding (HEVC/H.265), Advanced Video Coding (AVC/H.264), and Moving Picture Expert Group (MPEG) coding. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

HEVC, also known as H.265, is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC), also known as H.266, is a video compression standard intended as a successor to HEVC. ITU-T and ISO/IEC published the VVC/H.266 standard in 2020 (version 1) and 2022 (version 2). AV1 is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

As described in more detail below, some approaches of improving prediction accuracy by biasing (weighting) a prediction using reference samples (e.g., top and left reference samples) result in increased hardware requirements due to the corresponding calculations (e.g., a multiplication operation in an intermediate step of the prediction derivation process that results in a higher bit requirement). The systems and methods described herein eliminate the multiplication operation that has the higher bit requirement while still accounting for the neighboring samples, allowing precision to be improved during the calculations, in addition to simplifying the hardware.

In accordance with some embodiments, a method of video decoding is provided. The method includes (i) receiving a video bitstream (e.g., a coded video sequence) comprising a plurality of blocks, including a current block; and (ii) when the current block is encoded in a blend mode: (a) identifying a set of reference samples for the current block; (b) deriving an angular prediction value, Pa, for the current block according to Pₐ=Ref₁+((Len−1−x)·(Ref₂−Ref₁)+r>>Log₂ Len), where Ref₁ is a first reference sample from the set of reference samples, Ref₂ is a second reference sample from the set of reference samples, x is a coordinate of a current sample of the current block, Len is a length of the current block, and r is a rounding offset; (c) deriving a refined prediction value for the current block using a weighted sum of the second reference sample and the angular prediction value; and (d) decoding the current block based on the refined prediction value.

In accordance with some embodiments, a method of video encoding is provided. The method includes (i) receiving video data (e.g., a source video sequence) comprising a plurality of blocks, including a current block; when the current block is to be encoded in a blend mode: (ii) identifying a set of reference samples for the current block; (iii) deriving an angular prediction value, Pa, for the current block according to Pₐ=Ref₁+((Len−1−x)·(Ref₂−Ref₁)+r>>Log₂ Len), where Ref₁ is a first reference sample from the set of reference samples, Ref₂ is a second reference sample from the set of reference samples, x is a coordinate of a current sample of the current block, Len is a length of the current block, and r is a rounding offset; (iv) deriving a refined prediction value for the current block using a weighted sum of the second reference sample and the angular prediction value; and (v) encoding the current block based on the refined prediction value.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder component).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A shows an example of directional intra prediction mode angles in accordance with some embodiments.

FIGS. 4B-4C show example reference samples for a current block in accordance with some embodiments.

FIG. 5A is a flow diagram illustrating an example method of encoding video in accordance with some embodiments.

FIG. 5B is a flow diagram illustrating an example method of decoding video in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes, among other things, deriving intermediate variables for a blend prediction mode while eliminating a multiplication operation that imposes higher bit requirement on the derivation. In this way, coding accuracy can be improved (e.g., reducing artifacts in the decoded video) as compared to the other smooth prediction modes while reducing hardware requirements compared to methods that use the multiplication operation in the derivation of the intermediate variables. As an example, an angular prediction value, Pa, may be derived for a current block according to Pₐ=Ref₁+((Len−1−x)·(Ref₂−Ref₁)+r>>Log₂ Len), where Ref₁ is a first reference sample from the set of reference samples, Ref₂ is a second reference sample from the set of reference samples, x is a coordinate of a current sample of the current block, Len is a length of the current block, and r is a rounding offset.

### Example Systems and Devices

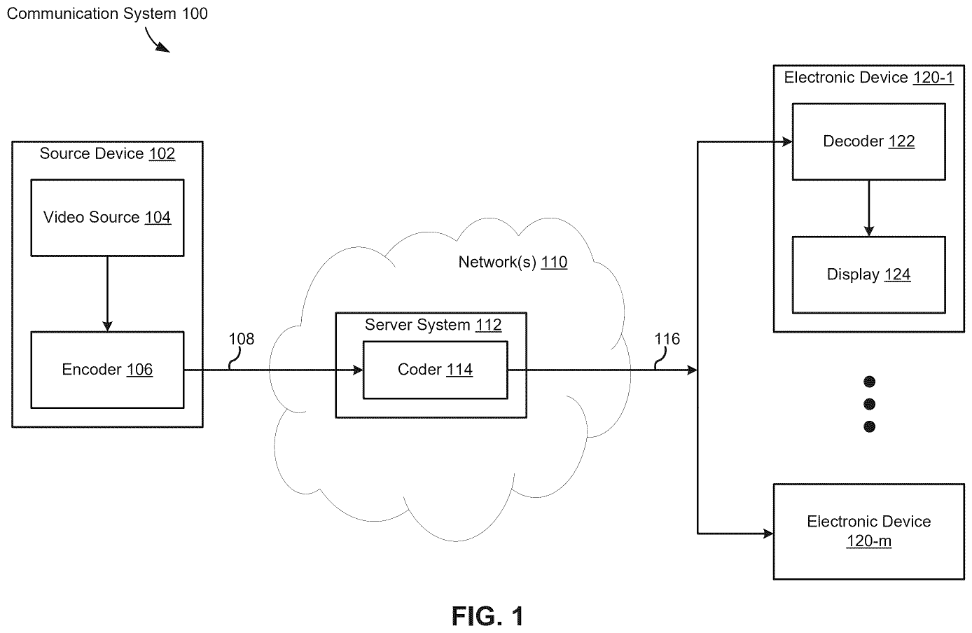

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108.

In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 to recover and optionally display the video pictures.

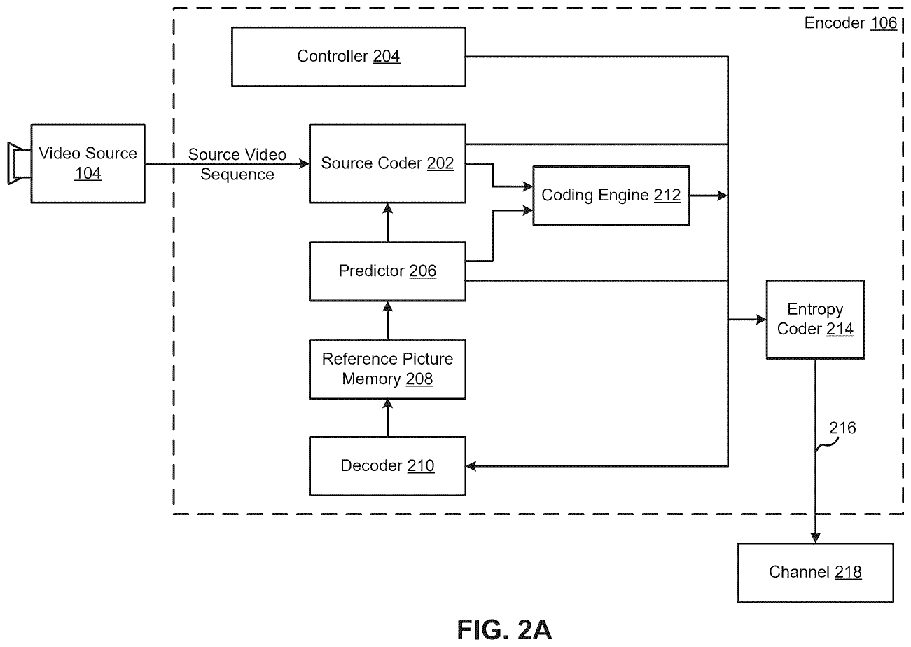

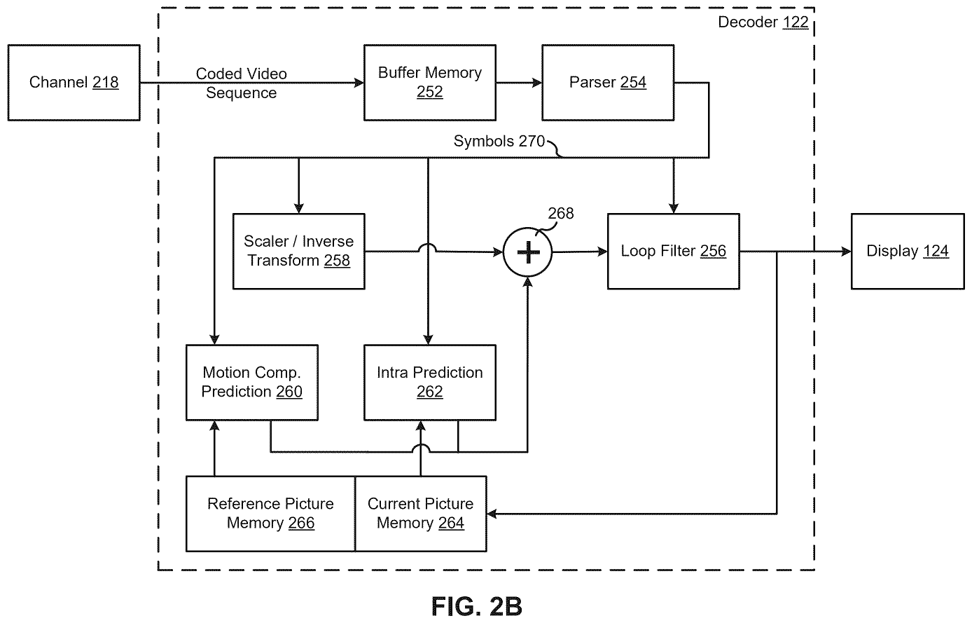

FIG. 2A is a block diagram illustrating example elements of the encoder component 106 in accordance with some embodiments. The encoder component 106 receives a source video sequence from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples. The description below focuses on samples.

The encoder component 106 is configured to code and/or compress the pictures of the source video sequence into a coded video sequence 216 in real-time or under other time constraints as required by the application. Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies. Only in certain areas is a more detail description is required and provided below.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. In some cases, as determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. In some embodiments, the decoder component 122 is implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and can be advantageously of adaptive size, and may at least partially be implemented in an operating system or similar elements (not depicted) outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values.

The output of the loop filter unit 256 can be a sample stream that can be output to a render device such as the display 124, as well as stored in the reference picture memory 266 for use in future inter-picture prediction.

Certain coded pictures, once fully reconstructed, can be used as reference pictures for future prediction. Once a coded picture is fully reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example mega samples per second), maximum reference picture size, and so on. Limits set by levels can, in some cases, be further restricted through Hypothetical Reference Decoder (HRD) specifications and metadata for HRD buffer management signaled in the coded video sequence.

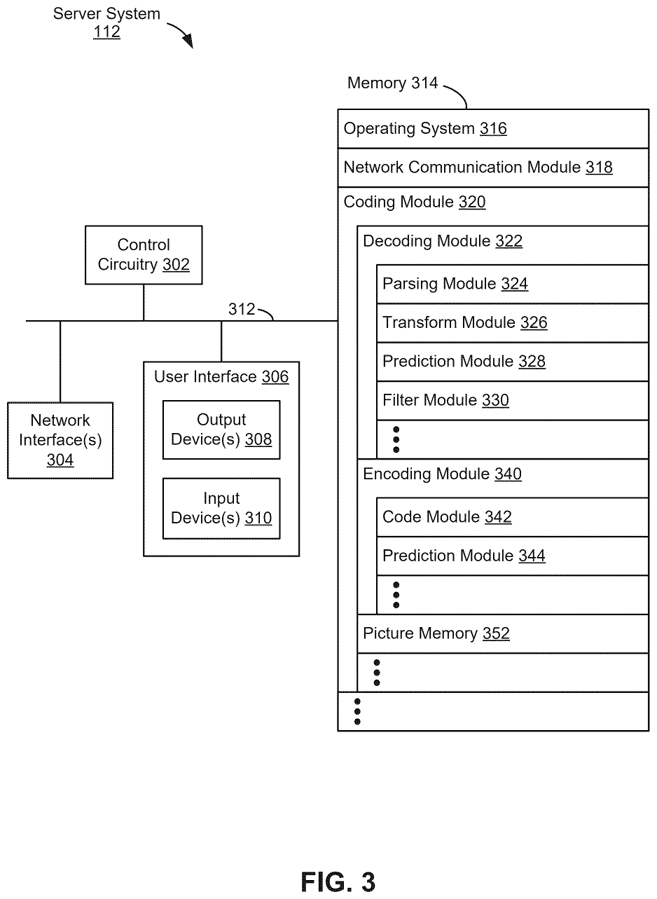

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Processes and Techniques

The coding processes and techniques described below may be performed at the devices and systems described above (e.g., the source device 102, the server system 112, and/or the electronic device 120).

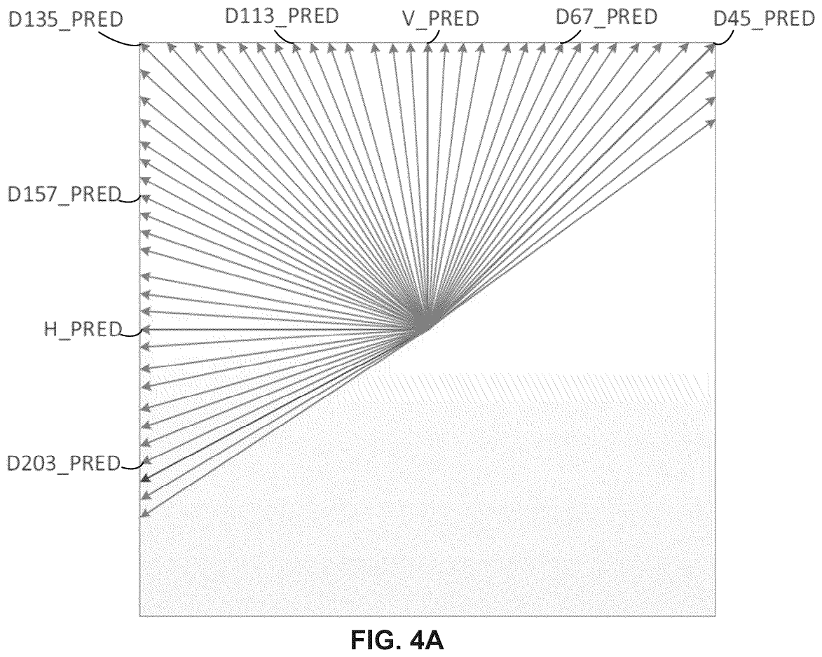

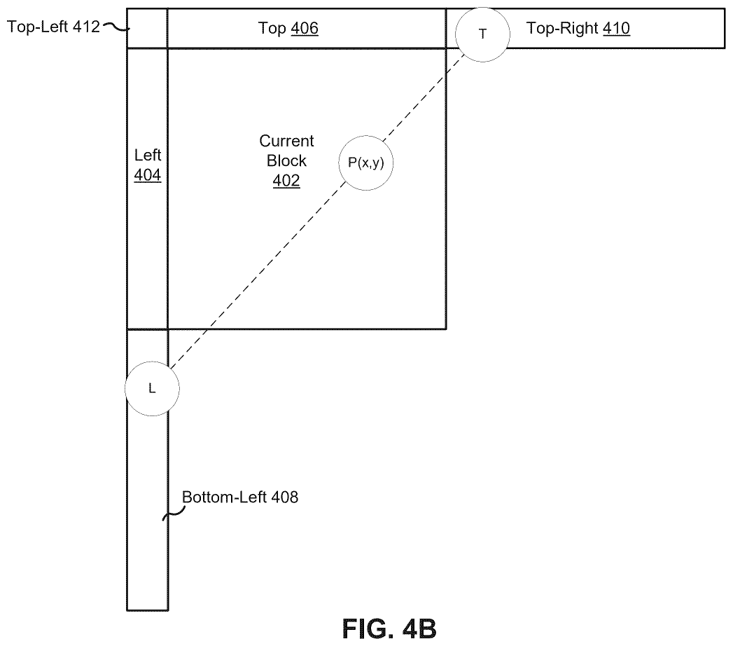

For directional intra prediction, some approaches support 8 directional modes, e.g., corresponding to angles from 45 to 207 degrees. To exploit more varieties of spatial redundancy in directional textures, directional intra modes may be extended to an angle set with finer granularity. For example, the 8 angles may be denoted as nominal angles. The 8 nominal angles, named V_PRED, H_PRED, D45_PRED, D135_PRED, D113_PRED, D157_PRED, D203_PRED, and D67_PRED, are shown in FIG. 4A. As also shown in FIG. 4A, for each nominal angle, there may be 7 finer angles for a total of 56 directional angles. A prediction angle may be described by a nominal intra angle plus an angle delta (e.g., −3-3 multiplied by a step size of 3 degrees).

In some approaches, there are also non-directional smooth intra prediction modes, e.g., DC, PAETH, SMOOTH-B (sometimes denoted as SMOOTH), SMOOTH-V, and SMOOTH-H. For a DC prediction, the average of the left and above neighboring samples may be used as the predictor of the block to be predicted. For a PAETH prediction, top, left, and top-left reference samples may be fetched, and the value which is closest to a given value (e.g., top+left−top-left) is set as the predictor for the pixel to be predicted. For SMOOTH-B, SMOOTH-V, and SMOOTH-H modes, the block may be predicted using quadratic interpolation in vertical or horizontal directions, or an average of both directions.

In some approaches, the SMOOTH-V and SMOOTH-H modes generate prediction values by using interpolation along the vertical and horizontal directions, respectively, while the SMOOTH-B mode generates prediction values using an average of the interpolation results along both directions. The top, left, top-right, and bottom-left neighboring reconstructed sample values may be denoted as T, L, TR and BL, respectively. The prediction sample values in the three modes may be calculated as follows,

$$SMOOTH - H mode$$

$$\begin{matrix}Equation 1 & \\ {P}_{H} ( x , y ) = w ( x ) \times L + ( 1 - w ( x ) ) \times TR & \end{matrix}$$

$$SMOOTH - V mode$$

$$\begin{matrix}Equation 2 & \\ {P}_{V} ( x , y ) = w ( y ) \times T + ( 1 - w ( y ) ) \times BL & \end{matrix}$$

$$SMOOTH - B mode$$

$$\begin{matrix}Equation 3 & \\ P ( x , y ) = ( {P}_{H} ( x , y ) + {P}_{V} ( x , y ) ) / 2 & \end{matrix}$$

where x denotes the horizontal coordinate of a prediction sample in a prediction block, y denotes the vertical coordinate of a prediction sample in a prediction block, w(x) and w(y) are weighting values derived based on the coordinate values, and P_{H}, P_{V} and P denote the prediction block of the SMOOTH-H, SMOOTH-V and SMOOTH-B mode, respectively. FIG. 4C illustrates the prediction process of the SMOOTH-V and SMOOTH-H modes, where w(y) and w(x) are non-linear weighting values derived based on the vertical coordinate and horizontal coordinate in the SMOOTH-V and SMOOTH-H mode, respectively. The weights may be stored in a lookup table.

In some systems, the smooth prediction modes (e.g., the SMOOTH-B, SMOOTH-H, and SMOOTH-V modes above), do not take into account the uneven distribution of available reference samples (e.g., only the top and left reference samples may be available) or non-linear weighting distribution of available reference samples, therefore the prediction accuracy of these smooth modes may be reduced as compared to modes that are weighted more heavily to the top and left reference samples. The systems and methods described below can improve the prediction accuracy and precision as compared to the smooth prediction modes shown in Equations 1-3 above. The methods and processes described below may be used separately or combined in any order. In the description below, if a mode generates prediction samples according to a given prediction direction, the mode referred to as a directional mode.

As used herein, the left reference samples refer to reference samples that are located with a vertical coordinate value within the minimum and maximum vertical coordinate values of the current block (e.g., current block 402) as shown by the left section 404 in FIG. 4B. The top reference samples refer to reference samples that are located with a horizontal coordinate value within the minimum and maximum horizontal coordinate values of the current block as shown by the top section 406 in FIG. 4A. The bottom-left reference samples refer to reference samples that are located with a vertical coordinate value greater than the maximum vertical coordinate values of the current block as shown by the bottom-left section 408 in FIG. 4B. The top-right reference samples refer to reference samples that are located with a horizontal coordinate value greater than the maximum horizontal coordinate values of the current block as shown by the top-right section 410 in FIG. 4B. The top-left reference samples refer to reference samples that are located with a horizontal coordinate value less than the minimum horizontal coordinate values of the current block and a vertical coordinate value less than the minimum vertical coordinate values of the current block as shown by the top-left section 412 in FIG. 4B.

In some systems, to predict a sample in the current block using spatially neighboring reference samples, a horizontal prediction value P_{H} is first derived, then a refined horizontal prediction value

$${P}_{H}^{′}$$

is derived using a weighted sum of a left reference sample (e.g., the reference sample with the same vertical coordinate) and P_{H}. The refined horizontal prediction value

$${P}_{H}^{′}$$

is used for the current sample prediction (e.g., corresponding to a SMOOTH-H mode). In some approaches, a vertical prediction value P_{V} is derived, then a refined vertical prediction value

$${P}_{V}^{′}$$

is derived using a weighted sum of a top reference sample (e.g., the reference sample with the same horizontal coordinate) and P_{V}. The refined vertical prediction value

$${P}_{V}^{′}$$

is used for the current sample prediction (e.g., corresponding to a SMOOTH-V mode). In some systems, a combined (final) prediction value P is derived as a weighted sum of

$${P}_{H}^{′} and {P}_{V}^{′} ,$$

and is used for the current sample prediction (e.g., corresponding to a SMOOTH-B mode).

In some approaches, the horizontal prediction value P_{H} is derived using a weighted sum of a left reference sample and one or more top (and/or top-right) reference samples. For example, the weighted sum may be based on a bilinear interpolation filtering. In some embodiments, the vertical prediction value P_{V} is derived using a weighted sum of a top reference sample and one or more left (and/or bottom-left) reference samples. For example, the weighted sum may be based on a bilinear interpolation filtering. In some embodiments, the left and above reference samples are filtered before generating P_{H} and/or P_{V} values. For example, the left and above reference samples may be filtered with smooth filters, such as a Gaussian filter or a bilateral filter, before generating the P_{H} and P_{V} values, where the coefficients of the smooth filters are non-negative integers.

In some systems, division operations (and/or right shift operations) in intermediate steps can reduce accuracy (e.g., the decimals are truncated due to the number of bits used to store the result of the division operation). Thus, performing a division operation when calculating P_{H} and/or P_{V} prior to calculating

$${P}_{H}^{′} and / or {P}_{V}^{′}$$

may cause

$${P}_{H}^{′} and / or {P}_{V}^{′}$$

to be less accurate. Therefore, it is advantageous to move the division operations to the end of the process (e.g., to the final step in calculating

$${P}_{H}^{′} , {P}_{V}^{′} ,$$

or P). Additionally, calculating the intermediate values without performing division can simplify the hardware logic needed to implement the calculations. Equations 4-8 below show division (and/or right shift) operations in calculating P_{H} and P_{V} being moved to the last derivation step for the combined (final) predictor. For example, during the internal calculation, a common value may be multiplied in to make each predictor have the same divider (or shift value).

$$\begin{matrix}Vertical Prediction Value via Linear Interpolation & \\ {P}_{V} ( x , y ) = ( T \cdot ( H - 1 - y ) + BL \cdot ( y + 1 ) ) \cdot W & Equation 4\end{matrix}$$

$$\begin{matrix}Blending with the Top Sample ( T ) For Refined Vertical Prediction Value & \\ {P}_{V}^{′} ( x , y ) = ( {w}_{T} \cdot W \cdot H \cdot T + ( N - {w}_{T} ) \cdot {P}_{V} ( x , y ) + 32 \cdot H \cdot W ) ≫ ( 6 + log 2 ( W ) or log 2 ( H ) ) & Equation 5\end{matrix}$$

$$\begin{matrix}Horizontal Prediction Value via Linear Interpolation & \\ {P}_{H} ( x , y ) = ( L \cdot ( W - 1 - x ) + TR \cdot ( x + 1 ) ) \cdot H & Equation 6\end{matrix}$$

$$\begin{matrix}Blending with the Left Sample ( T ) For Refined Horizontal Prediction Value & \\ {P}_{H}^{′} ( x , y ) = ( {w}_{L} \cdot W \cdot H \cdot L + ( N - {w}_{L} ) \cdot {P}_{H} ( x , y ) + 32 \cdot H \cdot W ) ≫ ( 6 + log 2 ( W ) or log 2 ( H ) ) & Equation 7\end{matrix}$$

$$\begin{matrix}Combined Prediction Value of BLEND mode & \\ P ( x , y ) = ( {P}_{H}^{′} ( x , y ) + {P}_{V}^{′} ( x , y ) + 1 ) ≫ 1 & Equation 8\end{matrix}$$

In Equations 4-8, the multiplication of W or H may be a left shift by the log₂(W) or log₂(H), and the intermediate values (e.g., P_{V},

$${P}_{V}^{′} , {P}_{H} , and {P}_{H}^{′} )$$

are performed without a division or right shift operation. In some approaches, N may be 64, or another value.

In some approaches, the storage of the intermediate value P_{H}(x, y), P_{V}(x, y) may require higher bits (e.g., 32 bits, 64 bits, or another value) due to the multiplication of a lower bit (e.g., 16-bit, 8-bit, or another value) sample value BL, T, TR, L with the block width W and height H (e.g., with a maximum of sample value×64×64, or another maximum value). The derivation of prediction samples introduces multiplication over 32-bit variables, as bolded in the equation below:

$$\begin{matrix}Refined Vertical Prediction Value with Bolded Portions that Introduce Higher - Bit Variables & \\ {P}_{V}^{′} ( x , y ) = ( {w}_{T} \cdot W \cdot H \cdot T + ( N - {w}_{T} ) \cdot {P}_{V} ( x , y ) + 32 \cdot H \cdot W ) ≫ ( 6 + log 2 ( W ) or log 2 ( H ) ) & Equation 5\end{matrix}$$

$$\begin{matrix}Refined Horizontal Prediction Value with Bolded Portions that Introduce Higher - Bit Variables & \\ {P}_{H}^{′} ( x , y ) = ( {w}_{L} \cdot W \cdot H \cdot L + ( N - {w}_{L} ) \cdot {P}_{H} ( x , y ) + 32 \cdot H \cdot W ) ≫ ( 6 + log 2 ( W ) or log 2 ( H ) ) & Equation 7\end{matrix}$$

For example, in the derivation of

$${P}_{H}^{′} ( x , y ) , ( N - {w}_{L} )$$

is an 8-bit value, P_{H}(x, y) is a 32-bit value.

In some embodiments, as described in greater detail below, an angular prediction value Pₐ is derived using reference samples from the top and/or the top-right neighboring positions of the current block along a given prediction angle. For example, Pₐ is derived using the following formula:

$$\begin{matrix}Intermediate Prediction Value & \\ {P}_{a} = {Ref}_{1} + ( ( Len - 1 - x ) \cdot ( {Ref}_{2} - {Ref}_{1} ) + r ) ≫ log 2 ( Len ) & Equation 9\end{matrix}$$

where Ref₁ may be T, the top/top right sample obtained by extending the left samples along the prediction angles to the top/top right as illustrated in FIG. 4B, or TR position in FIG. 4C. Ref₂ may be L, the left/left bottom sample may be obtained by extending the direction from top reference to the left/left bottom sample of the prediction value as illustrated in FIG. 4B, or L position in FIG. 4C. Len may be W, the block width. x is the horizontal coordinate of current sample to be predicted. r is a rounding offset that may be equal to 0.5·W.

In some embodiments, Pₐ′ is derived using the following formula

$$\begin{matrix}Refined Prediction Value & \\ {P}_{a}^{′} = {P}_{a} + ( w \cdot ( {Ref}_{2} - {P}_{a} ) + {r}^{′} ) ≫ N & Equation 10\end{matrix}$$

where w is a weighting value, r′ is another rounding offset, such as 32, and N is a predefined value, such as 6, or another value. In some embodiments, the use of Equations 9 and 10 to obtain the refined prediction value avoids the use of higher-bit multiplication (e.g., 32-bit multiplication, 64-bit multiplication, or multiplication of another bit value). In some embodiments, w can be derived as K>>((x<<1)>>s), where K is a pre-defined value (e.g., 16, 32 or 64), x is the horizontal coordinate of current sample to be predicted, s is a scaling factor based on the block size (e.g., s is equal to (log 2(W)+log 2(H)+2)>>2), and W and H are the block width and height, respectively. In some embodiments, if L is not available or outside of the left bottom reference sample, some of the predefined values in the left or left bottom may be used. In some embodiments, a predefined sample that in the region of left/left bottom can be used when L is out of the left bottom reference sample. In some embodiments, it is padded with the nearest available samples in the bottom-left, left, above-left, above, or above-right area. In some embodiments, r′ can be 0 and no rounding is implemented when P_{A}′ is derived.

In some embodiments, the angular prediction value P_{A}′ can optionally be clamped to a value range between 0 and n′−1, where n′ is a pre-defined value such as an integer that is a power of 2, 2\hat{ }8, 2\hat{ }10, 2\hat{ }12, 2\hat{ }14, 2\hat{ }16, 2\hat{ }32, or another value. In some embodiments, the angular prediction value P_{A}′ for the horizontal blend mode is derived as shown in Table 1 below:

TABLE 1
Example derivation of an angular prediction value
P_{A}′ associated with a horizontal blend mode.

```
static INLINE void highbd_smooth_h_predictor(uint16_t *dst, ptrdiff_t stride, int bw, int
bh, const uint16_t* above, const uint16_t*left, int bd){
(void)bd;
const uint16_t tr=above[bw];
uint16_t *pred=dst;
const int scale =
ROUND_POWER_OF_TWO((blk_size_log2[bh]−2+ blk_size_log2[bw]−2),2);
assert(scale >=0 && scale <=BLEND_WEIGHT_MAX −1);
for (int r=0; r<bh; r++) {
  const uint16_t l=left[r];
  for (int c=0; c<bw; c++) {
const int s_left= BLEND_WEIGHT_MAX >>
AOMMIN(blk_size_log2[BLEND_WEIGHT_MAX<<1], ((c<<1) >> scale));
int blend_max_log2= blk_size_log2[BLEND_WEIGHT_MAX];
uint16_t r=1<< (blk_size_log2[bw]−1);
uint16_t predh=clamp(tr+((((int16_t)left[r]−(int16_t)tr)*(bw−1−c)+r) >>
blk_size_log2[bw]), 0, (1<<bd)−1);
uint16_t r_prime=1<<blend_max_log2;
pred[c] = clamp(predh+ ((((int16_t)1−(int16_t)predh)*s_left+r_prime)
>>(blend_max_log2+1)), 0, (1<<bd)−1);
assert(pred[c]<(1<<bd));
}
pred +=stride;
}
}
```

In some embodiments, Equation 9 is used to determine an intermediate prediction value associated with a vertical blend mode. For the vertical blend mode, Ref₁ may be L, left/left bottom sample may be obtained by extending the direction from top reference to the left/left bottom sample of the prediction value as illustrated in FIG. 4B, or BL position in FIG. 4C. Ref₂ may be T, the top/top right sample obtained by extending the left samples along the prediction angles to the top/top right as illustrated in FIG. 4B, or the T position in FIG. 4C. Len may be H, the block height. x is the vertical coordinate of current sample to be predicted. r is a rounding offset that may be equal to 0.5·H.

In some embodiments, the angular prediction value P_{A}′ for the vertical blend mode can be clamped to a value range between 0 and n′−1, n′ is a pre-defined value with example values being an integer that is a power of 2, e.g., n′ can be 2\hat{ }8, 2\hat{ }10, 2\hat{ }12, 2\hat{ }14, 2\hat{ }16, 2\hat{ }32. In some embodiments, the vertical blend mode is applied to a mode that is below the H_PRED (e.g., D203_PRED, or another mode). In some embodiments, the angular prediction value P_{A}′ for the vertical blend mode is derived as shown in Table 2 below:

TABLE 2
Example derivation of an angular prediction value
P_{A}′ associated with the vertical blend mode.

```
static INLINE void highbd_smooth_h_predictor(uint16_t *dst, ptrdiff_t stride, int bw, int
bh, const uint16_t *above, const uint16_t *left, int bd){
(void)bd;
const uint16_t bl=left[bh];
uint16_t *pred=dst;
const int scale =
ROUND_POWER_OF_TWO((blk_size_log2[bh]−2+ blk_size_log2[bw]−2),2);
assert(scale >=0 && scale <=BLEND_WEIGHT_MAX −1);
for (int r=0; r<bh; ++r) {
  const int s_stop= BLEND_WEIGHT_MAX >>
AOMMIN(blk_size_log2[BLEND_WEIGHT_MAX<<1], ((r<<1) >> scale));
  for (int c=0; c<bw; ++c) {
const uint16_t top =above[c];
int blend_max_log2= blk_size_log2[BLEND_WEIGHT_MAX];
uint16_t r=1<< (blk_size_log2[bh]−1);
uint16_t predv=clamp(bl+((((int16_t)above[c]−(int16_t)bl)*(bh−1−r)+r) >>
blk_size_log2[bh]), 0, (1<<bd)−1);
uint16_t r_prime=1<<blend_max_log2;
pred[c] = clamp(predv+ ((((int16_t)top−(int16_t)predv)*s_top+r_prime)
>>(blend_max_log2+1)), 0, (1<<bd)−1);
assert(pred[c]<(1<<bd));
}
pred +=stride;
}
}
```

In some embodiments, a combined blend mode is derived by first deriving a vertical blend mode P_{V}′, and a horizontal blend mode P_{H}′, and a final prediction value P_{A}′ is derived by taking an average of P_{V}′ and P_{H}′. In some embodiments, the horizontal blend mode P_{H}′ is derived using the example derivation described in Table 1, and the vertical blend mode P_{V}′ is derived using the example derivation described in Table 2. In some embodiments, the angular prediction value P_{A}′ for a combined blend mode is derived as shown in Table 3 below:

TABLE 3
Example derivation of an angular prediction value
P_{A}′ associated with the combined blend mode.

```
static INLINE void highbd_smooth_h_predictor(uint16_t *dst, ptrdiff_t stride, int bw, int
bh, const uint16_t *above, const uint16_t *left, int bd){
(void)bd;
const uint16_t bl=left[bh];
const uint16_t tr=above[bw];
uint16_t *pred=dst;
const int scale =
ROUND_POWER_OF_TWO((blk_size_log2[bh]−2+ blk_size_log2[bw]−2),2);
assert(scale >=0 && scale <=BLEND_WEIGHT_MAX −1);
for (int r=0; r<bh; r++) {
  const int s_stop= BLEND_WEIGHT_MAX >>
AOMMIN(blk_size_log2[BLEND_WEIGHT_MAX<<1], ((r<<1) >> scale));
const uint16_t l =left [r];
  for (int c=0; c<bw; c++) {
const int s_left = BLEND_WEIGHT_MAX >>
AOMMIN(blk_size_log2[BLEND_WEIGHT_MAX<<1], ((c<<1) >> scale));
const uint16_t top =above[c];
int blend_max_log2= blk_size_log2[BLEND_WEIGHT_MAX];
uint16_t r_H=1<< (blk_size_log2[bh]−1);
uint16_t r_V=1<< (blk_size_log2[bw]−1);
uint16_t predv= clamp(bl+((((int16_t)above[c]−(int16_t)bl)*(bh−1−r)+r_V) >>
blk_size_log2[bh]), 0, (1<<bd)−1);
uint16_t predh= clamp(tr+((((int16_t)left[r]−(int16_t)tr)*(bw−1−c)+r_H) >>
blk_size_log2[bw]), 0, (1<<bd)−1);
uint16_t r_prime=1<<blend_max_log2;
predv= clamp(predv +((((int16_t)top−(int16_t)predv)*s_top + r_prime) >>
(blend_max_log2+1)), 0, (1<<bd)−1);
predh= clamp(predh +((((int16_t)l−(int16_t)predh)*s_left + r_prime) >>
(blend_max_log2+1)), 0, (1<<bd)−1);
pred[c] = divide_round((predv+ predh), 1);
assert(pred[c]<(1<<bd));
}
pred +=stride;
}
}
```

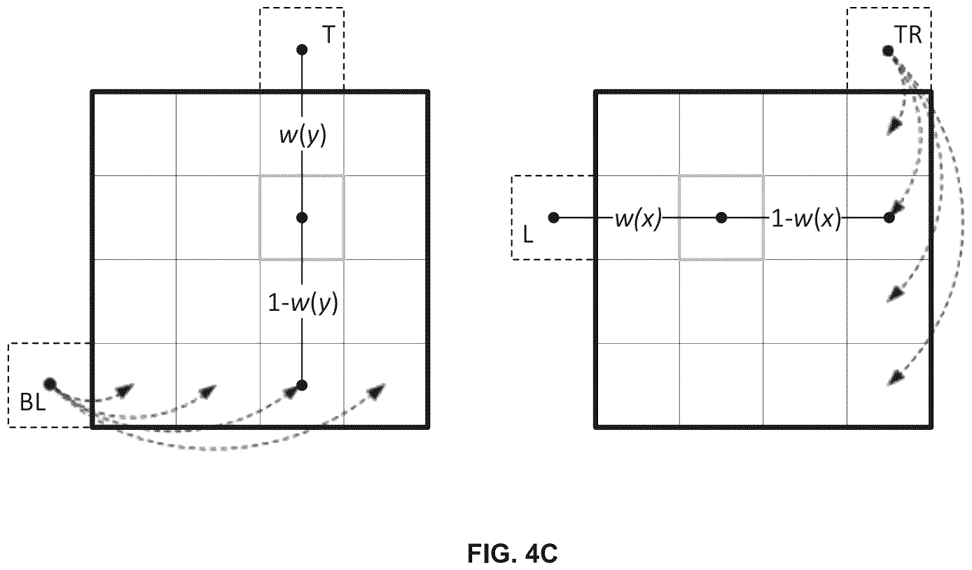

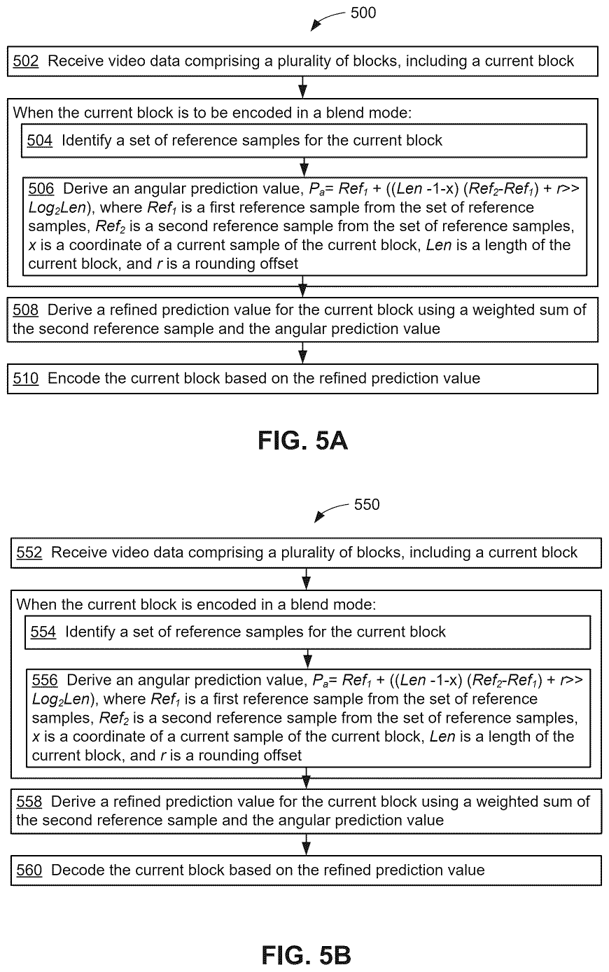

FIG. 5A is a flow diagram illustrating a method 500 of encoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) video data comprising a plurality of blocks, including a current block. When the current block is to be encoded in a blend mode, the system identifies (504) a set of reference samples for the current block. The system derives (506) an angular prediction value, Pa, for the current block according to Pₐ=Ref₁+ ((Len−1−x)·(Ref₂−Ref₁)+r>>Log₂ Len), where (i) Ref₁ is a first reference sample from the set of reference samples, (ii) Ref₂ is a second reference sample from the set of reference samples, (iii) x is a coordinate of a current sample of the current block, (iv) Len is a length of the current block, and (v) r is a rounding offset. The system derives (508) a refined prediction value for the current block using a weighted sum of the second reference sample and the angular prediction value. The system encodes (510) the current block based on the refined prediction value. In some embodiments, the system transmits the encoded current block via a video bitstream.

FIG. 5B is a flow diagram illustrating a method 550 of decoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data comprising a plurality of blocks, including a current block. When the current block is encoded in a blend mode, the system identifies (554) a set of reference samples for the current block. The system derives (556) an angular prediction value, Pₐ, for the current block according to Pₐ=Ref₁+ ((Len−1−x)·(Ref₂−Ref₁)+r>Log₂ Len), where (i) Ref₁ is a first reference sample from the set of reference samples, (ii) Ref₂ is a second reference sample from the set of reference samples, (iii) x is a coordinate of a current sample of the current block, (iv) Len is a length of the current block and (v) r is a rounding offset. The system derives (558) a refined prediction value for the current block using a weighted sum of the second reference sample and the angular prediction value. The system decodes (560) the current block based on the refined prediction value. As described previously, the decoding process may mirror the encoding processes described herein (e.g., deriving prediction values). For brevity, those details are not repeated here.

Although FIGS. 5A and 5B illustrates a number of logical stages in particular orders, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

In some embodiments, to predict a sample in a current block using spatially neighboring reference samples, an angular prediction value P_{A} is first derived, and the final prediction value P_{A}′ is derived using a weighted sum of the left reference sample and P_{A}. In some embodiments, the angular prediction value P_{A} is derived using reference samples from the top and/or the top-right neighboring positions of the current block along a given prediction angle. For example, P_{A} is derived using the following formula:

$$\begin{matrix}Intermediate Prediction Value & \\ {P}_{A} = T + ( ( W - 1 - x ) \cdot ( L - T ) + r ) / W & Equation 11\end{matrix}$$

where T may be the top/top right samples by extending the left samples along the prediction angles to the top/top right as illustrated in FIG. 4B, or TR position in FIG. 4C. L may be obtained by extending the direction from top reference to the left/left bottom sample of the prediction value as illustrated in FIG. 4B, or L position in FIG. 4C. W is the block width. x is the horizontal coordinate of current sample to be predicted. r is a rounding offset that may be equal to 0.5·W.

In some embodiments, the angular prediction value P_{A} can be clamped to a value range between 0 and n−1, n is a pre-defined value (e.g., an integer that is a power of 2, n can be 2\hat{ }8, 2\hat{ }10, 2\hat{ }12, 2\hat{ }14, 2\hat{ }16, 2\hat{ }32). In some embodiments, the reference samples may be filtered before generating the P_{A} values. In some embodiments, the left, above, above-left, bottom-left, and above-right reference samples are filtered with smooth filters, such as Gaussian filter or bilateral filter, before generating the P_{A} values. In some embodiments, the coefficients of the smooth filters are all non-negative integers.

In some embodiments, P_{A}′ is derived using the following formula

$$\begin{matrix}Refined Prediction Value & \\ {P}_{A}^{′} = {P}_{A} + ( {w}_{L} \cdot ( L - {P}_{A} ) + {r}^{′} ) / N & Equation 12\end{matrix}$$

where w_{L} is derived using the horizontal coordinate value of the current sample, N is a predefined value (e.g., an integer that is a power of 2, such as 2, 4, 8, 16, 32, 64, 128, 256, 512, or 1024), and r is a rounding offset (e.g., equal to 0.5·N). L is obtained by extending the direction from top reference to the left/left bottom sample of the prediction value as illustrated in FIG. 4B.

In some embodiments, w_{L} can be derived as K>>((x<<1)>>s), where K is a pre-defined value (e.g., 16, 32 or 64), x is the horizontal coordinate of current sample to be predicted, s is a scaling factor based on the block size (e.g., s is equal to (log 2(W)+log 2(H)+2)>>2), and W and H are the block width and height, respectively.

In some embodiments, if L is out of the left bottom reference sample, it could be refined by some of the predefined values in the left or left bottom. In some embodiments, a predefined sample that in the region of left/left bottom can be used when L is out of the left bottom reference sample. In some embodiments, it is padded with the nearest available samples in the bottom-left, left, above-left, above, or above-right area. In some embodiments, r′ can be 0 and no rounding is implemented when P_{A}′ is derived. In some embodiments, divisions in calculating the prediction samples for P_{A}′ are also moved to the last step for the final predictor, during the internal calculation, the parameters can multiply with some value that makes them have the same divider.

In some embodiments, the angular prediction value P_{A}′ can be clamped to a value range between 0 and n′−1, n′ is a pre-defined value (e.g., an integer that is a power of 2, such as 2\hat{ }8, 2\hat{ }10, 2\hat{ }12, 2\hat{ }14, 2\hat{ }16, 2\hat{ }32).

In some embodiments, this mode is applied when the angular mode is to the right of V_PRED in FIG. 4A and left sample may be found by extending the given angular direction to the left reference samples. In some embodiments, P_{A}′ is derived by the operations described in Table 1 above.

In some embodiments, to predict a sample in a current block using spatially neighboring reference samples, an angular prediction value P_{A} is first derived, and the final prediction value P_{A}′ is derived using a weighted sum of the top reference sample and P_{A}. In some embodiments, the angular prediction value P_{A} is derived using reference samples from the left and/or bottom left neighboring positions of the current block along a given prediction angle. For example, P_{A} is derived using the following formula:

$$\begin{matrix}Intermediate Prediction Value & \\ {P}_{A} = L + ( ( H - 1 - x ) \cdot ( T - L ) + r ) / H & Equation 13\end{matrix}$$

where T is the top/top right samples by extending the left samples along the prediction angles to the top/top right as illustrated in FIG. 4A, or T position in FIG. 4B. L may be obtained by extending the direction from top reference to the left/left bottom sample of the prediction value as illustrated in FIG. 4A, or BL position in FIG. 4B. H is the block width. x is the vertical coordinate of current sample to be predicted. r is a rounding offset (e.g., 0.5·W)

In some embodiments, the angular prediction value P_{A} can be clamped to a value range between 0 and n−1, n is a pre-defined value (e.g., an integer that is a power of 2, n can be 2\hat{ }8, 2\hat{ }10, 2\hat{ }12, 2\hat{ }14, 2\hat{ }16, 2\hat{ }32). In some embodiments, the reference samples may be filtered before generating the P_{A} values. In some embodiments, the left, above, above-left, bottom-left, and above-right reference samples are filtered with smooth filters, such as Gaussian filter or bilateral filter, before generating the P_{A} values. In some embodiments, the coefficients of the smooth filters are all non-negative integers.

In some embodiments, P_{A}′ is derived using the following formula

$$\begin{matrix}Refined Prediction Value & \\ {P}_{A}^{′} = {P}_{A} + ( {w}_{T} \cdot ( L - {P}_{A} ) + {r}^{′} ) / N & Equation 14\end{matrix}$$

where w_{T} is derived using the vertical coordinate value of the current sample, N is a predefined value (e.g., an integer that is a power of 2, such as 2, 4, 8, 16, 32, 64, 128, 256, 512, or 1024), and r′ is a rounding offset (e.g., equal to 0.5·N). T is obtained by extending the left samples along the prediction angles to the top/top right as illustrated in FIG. 4A.

In some embodiments, w_{T} can be derived as K>> ((x<<1)>>s), where K is a pre-defined value (e.g., 16, 32 or 64), x is the vertical coordinate of current sample to be predicted, s is a scaling factor based on the block size (e.g., s is equal to (log 2(W)+log 2(H)+2)>>2), and W and H are the block width and height, respectively.

In some embodiments, if T is out of the top/top right reference samples, predefined samples in the top/top right regions are assigned to T. In some embodiments, it is padded with the nearest available samples in the above-right, above, above-left, left, bottom-left area. In some embodiments, r′ can be 0 and no rounding is implemented when P_{A}′ is derived.

In some embodiments, divisions in calculating the prediction samples for P_{A}′ are also moved to the last step for the final predictor, during the internal calculation, the parameters can be multiplied with a value to make them have the same divider.

In some embodiments, the angular prediction value P_{A}′ can be clamped to a value range between 0 and n′−1, n′ is a pre-defined value (e.g., an integer that is a power of 2, such as 2\hat{ }8, 2\hat{ }10, 2\hat{ }12, 2\hat{ }14, 2\hat{ }16, 2\hat{ }32).

In some embodiments, this mode is applied when the angular mode is below the H_PRED. In some embodiments, P_{A}′ is derived by the operations described in Table 2 above.

In some embodiments, to predict a sample in a current block using spatially neighboring reference samples, a vertical blend mode P_{V}′, and a horizontal blend mode P_{H}′ are first derived, and a final prediction value P_{A}′ is derived by taking an average of P_{V}′ and P_{H}′. In some embodiments, the horizontal blend mode P_{H}′ is derived using the example derivation described in Table 1, and the vertical blend mode P_{V}′ is derived using the example derivation described in Table 2. In some embodiments, the prediction value P_{A} is derived using the following formula:

$$\begin{matrix}Refined Prediction Value & \\ {P}_{A}^{′} = ( {P}_{H}^{′} + {P}_{V}^{′} + 1 ) / 2 & Equation 15\end{matrix}$$

In some embodiments, P_{A}′ is derived by the operations described in Table 3 above. In some embodiments, whether to use the blend mode is signaled at sequence header, slice header, super block, or coding block level.

In some embodiments, if a block is intra mode, the blend mode is used. If a block is intra-inter mode, the blend mode is not applied. When a block is coded in intra-inter mode, the original intra mode (e.g., SMOOTH, SMOOTH-V, and SMOOTH-H modes of AV1) is used.

In some embodiments, predicted sample values are derived in a manner that avoids 32-bit multiplication during the blending process (e.g., using Equations 9 and 10). Table 4 below illustrates the improvements to signal-to-noise ratio based on simulations performed using current designs (e.g., AVM research-v9) with various video data (e.g., representing AOM Test Conditions).

TABLE 4
Simulation Results

| | Y-PSNR | U-PSNR | V-PSNR | YUV-PSNR |
|---|---|---|---|---|
| All Intra | −0.03% | −0.11% | −0.07% | −0.04% |
| RA | −0.01% | −0.20% | 0.10% | −0.02% |
| LD | 0.01% | −0.16% | −0.07% | 0.00% |

(A1) In one aspect, some embodiments include a method (e.g., the method 550) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes: (i) receiving a video bitstream comprising a plurality of blocks, including a current block; and when the current block is encoded in a blend mode: (ii) identifying a set of reference samples for the current block; (iii) deriving an angular prediction value, Pa, for the current block according to Pₐ=Ref₁+ ((Len−1−x). (Ref₂−Ref₁)+r>>Log₂ Len). Ref₁ is a first reference sample from the set of reference samples, Ref₂ is a second reference sample from the set of reference samples, x is a coordinate of a current sample of the current block, Len is a length of the current block, and r is a rounding offset. The method includes (iv) deriving a refined prediction value for the current block using a weighted sum of the second reference sample and the angular prediction value; and (v) decoding the current block based on the refined prediction value. In this way, to predict the sample in the current block using spatially neighboring reference samples, an angular prediction value, P_{A}, is first derived, then final prediction value, P_{A}′, is derived using weighted sum of the left reference sample and P_{A}. As another example, to predict the sample in the current block using spatially neighboring reference samples, an angular prediction value PA is first derived, then final prediction value PA′ is derived using weighted sum of the top reference sample and PA. In some embodiments, in accordance with a determination that the current block is encoded in a blend mode, an angular prediction value is derived, and a refined prediction value for the current block is derived using a weighted sum of a reference sample and the angular prediction value. In some embodiments, the rounding offset is equal to half of the length of the current block. In some embodiments, if a block is intra mode, the blend mode is used. In some embodiments, if a block is intra-inter mode, the blend mode is not applied. In some embodiments, if it is intra-inter mode, the original intra mode, such as smooth, smooth-v, or smooth-h mode is used.

(A2) In some embodiments of A1, the refined prediction value, P′ₐ, is derived according to

$${P}_{a}^{′} = {P}_{a} + ( w \cdot ( {Ref}_{2} - {P}_{a} ) + {r}^{′} ) ≫ N ,$$

where w is a weighting value, r′ is another rounding offset, and N is a predefined value. In some embodiments, P′ₐ is derived using Equation 12. In some embodiments, P′ₐ is derived using Equation 14. In some embodiments, a shift operation is used in place of the division operation shown in the Equations. In some embodiments, w is derived using the horizontal coordinate value of the current sample. In some embodiments, N is an integer that is a power of 2, such as 2, 4, 8, 16, 32, 64, 128, 256, 512, 1024. In some embodiments, r′ is equal to half of N. In some embodiments, Ref₂ is obtained by extending the direction from top reference to the left/left bottom sample of the prediction value. In some embodiments, r′ is equal to zero.

(A3) In some embodiments of A2, w is derived according to w=K>>((x<<1)>>s), where K is a predefined value, and s is a scaling factor. In some embodiments, K is an integer that is a power of 2, such as 16, 32, or 64. In some embodiments, x is the horizontal coordinate of current sample to be predicted. In some embodiments, s is equal to (log 2(W)+log 2(H)+2)>>2, where W is a width of the current block and H is a height of the current block.

(A4) In some embodiments of A2 or A3, the second reference sample is refined prior to being used to derive the refined prediction value. For example, if Ref₂ is out of the left bottom reference sample, it could be refined by some of the predefined values in the left or left bottom. In some embodiments, a predefined sample that is in the region of the left/left bottom is used when Ref₂ is out of the left bottom reference sample. As an example, if Ref₂ is out of the top/top right reference samples, a predefined samples that in top/top right regions are assigned to Ref₂. In some embodiments, Ref₂ is padded with the nearest available samples in the bottom-left, left, above-left, above, or above-right area.

(A5) In some embodiments of any of A1-A4, deriving the refined prediction value comprises only performing a division or shift operation as a final step of deriving the refined prediction value. For example, the divisions in calculating the prediction samples for P′ₐ are moved to the last step for the final predictor and, during the internal calculation, the parameters multiply with value(s) that allows them to have the same divider.

(A6) In some embodiments of any of A1-A5, the method further includes clamping the angular prediction value to a range of values. In some embodiments, the angular prediction value is clamped to a value range between 0 and n−1, where n is a predefined value. For example, n may be an integer that is a power of 2, such as 2\hat{ }8, 2\hat{ }10, 2\hat{ }12, 2\hat{ }14, 2\hat{ }16, or 2\hat{ }32.

(A7) In some embodiments of any of A1-A6, the method further includes clamping the refined prediction value to a range of values. In some embodiments, the refined prediction value is clamped to a value range between 0 and n−1, where n is a predefined value. For example, n may be an integer that is a power of 2, such as 2\hat{ }8, 2\hat{ }10, 2\hat{ }12, 2\hat{ }14, 2\hat{ }16, or 2\hat{ }32.

(A8) In some embodiments of any of A1-A7, the method further includes generating a filtered reference set by filtering the set of reference samples, where the first reference sample and the second reference sample are selected from the filtered reference set. For example, the reference samples may be filtered before generating P_{A} values.

(A9) In some embodiments of A8, the filtered reference set is generated by applying a smooth filter to the set of reference samples. For example, the left, above, above-left, bottom-left, and above-right reference samples may be filtered with smooth filters, such as Gaussian filter or bilateral filter, before generating P_{A} values. In this example, the coefficients of the smooth filters are all non-negative integers.

(A10) In some embodiments of any of A1-A9, when a prediction angle of the current block is greater than a first threshold value, the refined prediction value comprises a horizontal blend mode prediction that includes identifying the second reference sample by extending an angular direction of the prediction angle to the left of the current block; and when a prediction angle of the current block is less than a second threshold value, the refined prediction value comprises a vertical blend mode prediction that includes identifying the second reference sample by extending an angular direction of the prediction angle to the top of the current block. For example, the horizontal blend mode may be applied when the angular mode is to the right of V_PRED (e.g., and it could find the left sample by extending the given angular direction to the left reference samples). For example, the vertical blend mode may be applied to the mode that is below the H_PRED.

(A11) In some embodiments of any of A1-A10, the method further includes deriving a combined prediction value by combining the refined prediction value with another refined prediction value, where decoding the current block comprises using the combined prediction value. For example, to predict the sample in the current block using spatially neighboring reference samples, a vertical blend mode P_{V}′, and a horizontal blend mode P_{H}′ are first derived, then final prediction value P_{A}′ is derived using average of the P_{V}′ and P_{H}′.

(A12) In some embodiments of A11, the combined prediction value, P′ₐ, is derived according to

$${P}_{a}^{′} = ( {P}_{H}^{′} + {P}_{V}^{′} + 1 ) / 2 ,$$

where P′_{H} is the refined prediction value and P′_{V} is the other refined prediction value. In some embodiments, the combined prediction value is derived using a shift operation instead of a division operation.

(A13) In some embodiments of any of A1-A12, the blend mode is a horizontal blend mode, and the first reference sample is a reference sample above the current block. In some embodiments, the angular prediction value is derived using the reference samples from top and/or top-right neighboring positions of current block along a given prediction angle. In some embodiments, the angular prediction value is derived using Equation 11. In some embodiments, a shift operation is used in place of the division operation shown in the Equation.

(A14) In some embodiments of A13, the second reference sample is a reference sample left of the current block.

(A15) In some embodiments of any of A1-A12, the blend mode is a vertical blend mode, and the first reference sample is a reference sample left the current block. In some embodiments, the angular prediction value PA is derived using the reference samples from top and/or top-right neighboring positions of current block along a given prediction angle. In some embodiments, the angular prediction value is derived using Equation 13. In some embodiments, a shift operation is used in place of the division operation shown in the Equation.

(A16) In some embodiments of A15, the second reference sample is a reference sample above of the current block.

(A17) In some embodiments of any of A1-A16, the method includes parsing a syntax element of the video bitstream, where the syntax element indicates whether the current block is encoded in a blend mode. In some embodiments, the syntax element is a high-level syntax. As an example, whether to use the blend mode is signaled at sequence header, slice header, super block, or coding block level.

(A18) In some embodiments of any of A1-A17, the length of the current block comprises a width or height of the current block. In some embodiments, the coordinate of the current sample comprises a horizontal coordinate or vertical coordinate for the current sample.

(B1) In another aspect, some embodiments include a method of video encoding (e.g., the method 500). In some embodiments, the method is performed at a computing system (e.g., the server system 112) having memory and control circuitry. In some embodiments, the method is performed at a coding module (e.g., the coding module 320). In some embodiments, the method is performed at a parser (e.g., the parser 254), a motion prediction component (e.g., the motion compensation prediction unit 260), and/or an intra prediction component (e.g., intra picture prediction unit 262). The method includes: (i) receiving video data comprising a plurality of frames; when the current block is to be encoded in a blend mode: (ii) identifying a set of reference samples for the current block; (iii) deriving an angular prediction value, Pa, for the current block according to Pₐ=Ref₁+ ((Len−1−x). (Ref₂−Ref₁)+r>>Log₂ Len). Ref₁ is a first reference sample from the set of reference samples, Ref₂ is a second reference sample from the set of reference samples, x is a coordinate of a current sample of the current block, Len is a length of the current block, and r is a rounding offset. The method further includes (iv) deriving a refined prediction value for the current block using a weighted sum of the second reference sample and the angular prediction value; and (v) encoding the current block based on the refined prediction value.

(B2) In some embodiments of B1, the method further comprises transmitting the video bitstream including the encoded current block.

(B3) In some embodiments of B1 or B2, the method further includes encoding-side analogues of any of the features described above with respect to A1-A18.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 500 and 550 as well as A1-A18 and B1-B3 above).

In yet another aspect, some embodiments include a non-transitory computer-readable storage medium storing one or more sets of instructions for execution by control circuitry of a computing system, the one or more sets of instructions including instructions for performing any of the methods described herein (e.g., the methods 500 and 550 as well as A1-A18 and B1-B3 above).

Unless otherwise specified, any of the syntax elements described herein may be HLS. As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block; and
when the current block is encoded in a blend mode:
identifying a set of reference samples for the current block;
deriving an angular prediction value, Pₐ, for the current block according to Pₐ=Ref₁+((Len−1−x)·(Ref₂−Ref₁)+r>>Log₂ Len), wherein Ref₁ is a first reference sample from the set of reference samples, Ref₂ is a second reference sample from the set of reference samples, x is a coordinate of a current sample of the current block, Len is a length of the current block, and r is a rounding offset;
deriving a refined prediction value for the current block using a weighted sum of the second reference sample and the angular prediction value; and
decoding the current block based on the refined prediction value.

2. The method of claim 1, wherein the refined prediction value, P′ₐ, is derived according to
$${P}_{a}^{′} = {P}_{a} + ( w \cdot ( {Ref}_{2} - {P}_{a} ) + {r}^{′} ) ≫ N ,$$
wherein w is a weighting value, r′ is another rounding offset, and N is a predefined value.

3. The method of claim 2, wherein w is derived according to w=K>>((x<<1)>>s), wherein K is a predefined value, and wherein s is a scaling factor.

4. The method of claim 2, wherein the second reference sample is refined prior to being used to derive the refined prediction value.

5. The method of claim 1, wherein deriving the refined prediction value comprises only performing a division or shift operation as a final step of deriving the refined prediction value.

6. The method of claim 1, further comprising clamping the angular prediction value to a range of values.

7. The method of claim 1, further comprising clamping the refined prediction value to a range of values.

8. The method of claim 1, further comprising generating a filtered reference set by filtering the set of reference samples, wherein the first reference sample and the second reference sample are selected from the filtered reference set.

9. The method of claim 8, wherein the filtered reference set is generated by applying a smooth filter to the set of reference samples.

10. The method of claim 1, wherein:
when a prediction angle of the current block is greater than a first threshold value, the refined prediction value comprises a horizontal blend mode prediction that includes identifying the second reference sample by extending an angular direction of the prediction angle to the left of the current block; and
when a prediction angle of the current block is less than a second threshold value, the refined prediction value comprises a vertical blend mode prediction that includes identifying the second reference sample by extending an angular direction of the prediction angle to the top of the current block.

11. The method of claim 1, further comprising deriving a combined prediction value by combining the refined prediction value with another refined prediction value, wherein decoding the current block comprises using the combined prediction value.

12. The method of claim 11, wherein the combined prediction value, P′ₐ, is derived according to
$${P}_{a}^{′} = \frac{{P}_{H}^{′} + {P}_{V}^{′} + 1}{2} ,$$
wherein P′_{H} is the refined prediction value and wherein P′_{V} is the other refined prediction value.

13. The method of claim 1, wherein the blend mode is a horizontal blend mode, and wherein the first reference sample is a reference sample above the current block.

14. The method of claim 13, wherein the second reference sample is a reference sample left of the current block.

15. The method of claim 1, wherein the blend mode is a vertical blend mode, and wherein the first reference sample is a reference sample left the current block.

16. The method of claim 15, wherein the second reference sample is a reference sample above of the current block.

17. The method of claim 1, further comprising parsing a syntax element of the video bitstream, wherein the syntax element indicates whether the current block is encoded in a blend mode.

18. The method of claim 1, wherein the length of the current block comprises a width or height of the current block.

19. A method of video encoding performed at a computing system having memory and one or more processors, the method comprising:
receiving video data comprising a plurality of blocks, including a current block;
when the current block is to be encoded in a blend mode:
identifying a set of reference samples for the current block;
deriving an angular prediction value, Pₐ, for the current block according to Pₐ=Ref₁+(Len−1−x)·(Ref₂−Ref₁)+r>>Log₂ Len), wherein Ref₁ is a first reference sample from the set of reference samples, Ref₂ is a second reference sample from the set of reference samples, x is a coordinate of a current sample of the current block, Len is a length of the current block, and r is a rounding offset;
deriving a refined prediction value for the current block using a weighted sum of the second reference sample and the angular prediction value; and
encoding the current block based on the refined prediction value.

20. A non-transitory computer-readable storage medium storing a video bitstream that is generated by a video encoding method, the video encoding method comprising:
when a current block of video data is to be encoded in a blend mode:
identifying a set of reference samples for the current block;
deriving an angular prediction value, Pₐ, for the current block according to Pₐ=Ref₁+ ((Len−1−x)·(Ref₂−Ref₁)+r>>>Log₂ Len), wherein Ref₁ is a first reference sample from the set of reference samples, Ref₂ is a second reference sample from the set of reference samples, x is a coordinate of a current sample of the current block, Len is a length of the current block, and r is a rounding offset;
deriving a refined prediction value for the current block using a weighted sum of the second reference sample and the angular prediction value; and
encoding the current block based on the refined prediction value; and
wherein the video bitstream comprises the encoded current block.
